(19) United States
(12) Patent Application Publication
(10) Pub. No.: US 2003/0118190 A1
(43) Pub. Date: Jun. 26, 2003

(54) Method and apparatus for processing data where a part of the current supplied is supplied to an auxiliary circuit

(75) Inventors: Holger Sedlak, Egmating (DE); Peter Sohne, Wiesbaden (DE); Michael Smola, Munchen (DE); Stefan Wallstab, Munchen (DE)

Correspondence Address: WERNER H. STEMER, P.O. Box 2480, Hollywood, FL, 33022, US

(73) Assignee: Siemens Aktiengesellschaft

(21) Appl. No.: 10/360,454

(22) Filed: Feb. 6, 2003

Related U.S. Application Data
(63) Continuation-in-part of application No. 09/106,236, filed on Jun. 29, 1998.

(30) Foreign Application Priority Data
May 29, 1998 (DE) 198 24 163.1

(51) Int. Cl. H04L 9/00

(52) U.S. Cl. 380/277; 713/194

(57) ABSTRACT

A data processing method where data to be processed is feed to a processing unit. Supplying a current to the processing unit for operating the processing unit and supplying in a randomly controlled manner a part of the current fed to the processing unit, to an auxiliary circuit.

### CROSS-REFERENCE TO RELATED APPLICATION

This application is a continuation-in-part of copending U.S. application No. 09/106,236, filed Jun. 29, 1998.

### BACKGROUND OF THE INVENTION

Field of the Invention

The invention relates to a method and apparatus for processing data. In the context of customary data processing, securing aspects are increasingly relevant nowadays since attempts are increasingly made to obtain data from data processing systems without permission. In order to prevent the this, cryptographic methods in which data to be protected are encrypted are increasingly being employed. To that end, the “public key method” is used inter alia, for example, in the case of which each subscriber of a system has a pair of keys comprising a secret key part and a public key part. The security of the subscribers is then based on the fact that the secret key part is not known to unauthorized entities. The embodiment of a method of this type is frequently effected in a specially protected component, such as, for example, a smart card, but also in an electronic circuit—also known as IC—which is mounted in a device, the method itself then being realized in these. Consequently, the secret part of the key need not leave this protected component.

Recently, however, attacks have become known in which an attempt is made to covertly observe the key in the protected component. This is supposed to be made possible, for example, by measuring the current consumption of the protected component. By virtue of frequently repeated observation of the current profile and given knowledge of how the encryption operation is carried out, it is ultimately possible to draw conclusions regarding the key.

### SUMMARY OF THE INVENTION

The invention is based on the object, therefore, of providing a method for data processing and a data processing apparatus which provides a higher level of protection against covert observation of protected data.

This object is achieved according to the invention by a method where data to be processed is feed to a processing unit and where a part of the current supplied to the processing unit for operating the processing unit, is feed in a randomly controlled manner to an auxiliary circuit.

In one embodiment of the invention, the method has the step of supplying the part of the current to the auxiliary circuit is performed using a randomly controlled circuit.

In another embodiment of the invention, the method uses at least one capacitor which is reloaded using the current supplied to the auxiliary circuit.

This object is achieved according to the invention by a data processing apparatus having a computing device which is fed data for processing and which is operated by a current, and an auxiliary circuit connected in parallel to the computing device and a random number generator controlling the auxiliary circuit.

In one embodiment of the invention, the auxiliary circuit has at least one capacitor which is reloaded by a switch controlled by the random number generator.

By virtue of the fact that part of the current supplied to the data processing apparatus is supplied to an auxiliary circuit, even with a repeated measurements of the current consumption, it is not possible to draw any conclusions regarding the processed data.

Other features which are considered as characteristic for the invention are set forth in the appended claims.

Although the invention is illustrated and described herein as embodied in method and apparatus for processing data where a part of the current supplied is supplied to an auxiliary circuit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows a first exemplary embodiment of an apparatus according to the invention,

FIG. 2 shows a second exemplary embodiment of an apparatus according to the invention, in which the method according to the invention is also explained, and

FIG. 3 shows a third exemplary embodiment.

### DESCRIPTION OF THE PREFERRED EMBODIMENTS

Reference numerals 1, 2 designate a circuit or processing unit to be protected, which comprises a microcontroller 2 and an arithmetic unit 1, for example. In this case, the microcontroller 2 controls the arithmetic unit 1, in which an encryption operation is carried out, for example. This arrangement to be protected is then fed a current I, which can be detected by means of a measuring device 7, as a result of which conclusions are to be drawn regarding the operations in the circuit 1, 2 to be protected. An additional circuit device 6 is now provided which is controlled via a random number generator 3. This random number generator may be designed, for example, as a sequence generator in the form of a linear feedback shift register which, loaded with a start value, generates a pseudo random sequence—zeros and ones. In this case, the start value may either be generated randomly or by the control device, for example on the basis of the key word; a combination of both possibilities is also conceivable. The sequence thus generated by the random number generator then controls switches S in the additional circuit device 6, with the result that capacitors connected in series with the switches S are charged in accordance with the random sequence that is currently generated in each case. In this way, the current consumption of the circuit 1, 2 to be protected is masked by the additional circuit device 6, namely the charging current of the capacitors. In order to minimize the total current consumption of this device, it is not necessary for the additional or auxiliary circuit device 6 to constantly contribute to the current consumption. Rather, it can be limited to operating only in the time during encryption and/or decryption.

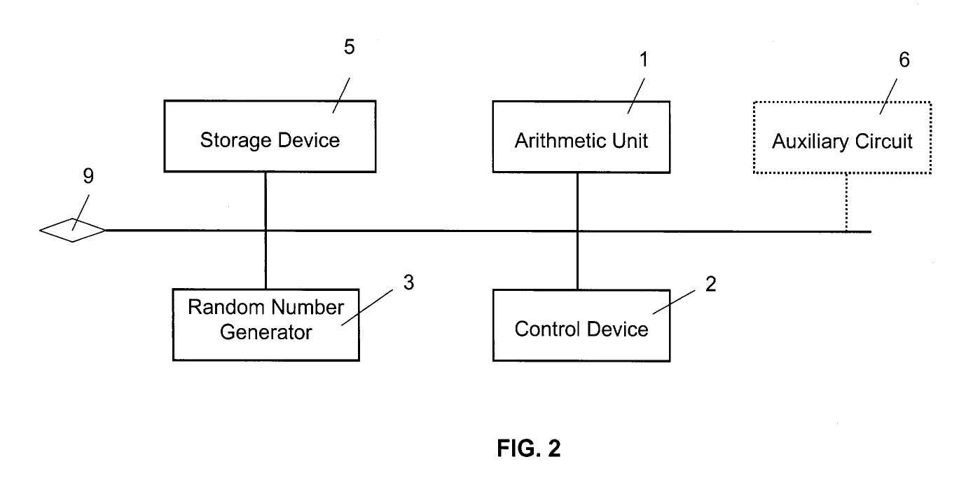

FIG. 2 shows a further exemplary embodiment according to the invention. In this case, the arithmetic unit 1 and the control device 2, the random number generator 3 and a storage device 5 are connected to a common bus or feeding apparatus 4, which is externally accessible by means of an interface 9. Data to be encrypted and/or decrypted are fed, for example, via the interface 9. A secret key word is stored in the storage device 5 and, under the control of the control device 2, is fed to the arithmetic unit 1 in order to encrypt and/or decrypt the data fed from the data bus via the interface 9. The random number generator 3 then generates a random number which is fed to the control device 2, which then controls the arithmetic unit 1 on the basis of this random number. Two possibilities are now conceivable in this case.

The arithmetic unit 1 is controlled by the control device 2 on the basis of the random number in such a way that the encryption or decryption algorithm is modulated in accordance with the respective random number. This means that arithmetic operations are consequently carried out in the encryption and/or decryption algorithm which operate with random values without ultimately effecting the encryption and/or decryption.

Examples of the variations of the encryption and/or decryption algorithm are described below.

A known method is the so-called RSA method. It operates in the group of relative prime residual classes modulo N and composes the exponentiations from multiplications modulo N. The variants of these protocols for elliptic curves modulo p have fundamental operations composed of modular additions and multiplications, so-called additions and duplications in the group of points of the elliptic curves, which are in turn composed for the purpose of exponentiation. The third large group comprises elliptic curves over finite fields whose element numbers are a prime power, which is frequently a power of 2. These structures are generally referred to as GF(pⁿ). The base arithmetic in these fields can be carried out by representing the field elements as polynomials with coefficients from the ground field GF(p) or a suitable intermediate field, which are combined with one another by multiplications modulo a fixed field polynomial and are added in a coefficient-by-coefficient manner. In this sense, it is possible to interpret operations in GF(pⁿ) or in elliptic curves over this field as a modular arithmetic operation. In this case, the following three variation possibilities corresponding to the method according to the invention are possible.

a) The module N is replaced by r*N, where r is a random number other than 0. In the GF(pⁿ) case, the field polynomial is replaced by its product with a randomly chosen polynomial other than 0. This step is to be carried out before entering the calculation or before a partial step and is subsequently to be compensated for by a reduction of the result or partial result modulo N.

b) An input parameter X of a modular arithmetic operation is replaced by the value X+s*N, where s is a random number. This can be carried out in different computation steps. The corresponding alteration of a plurality of input parameters of the same operation is also possible.

c) The exponents E are replaced by E+t*q, where t is a random number and q is the so-called order of the base of the exponentiation to be implemented, or a suitable multiple thereof. Potential values of q can frequently be derived from the system parameters. Thus, it is possible to choose q=(N) with the exponentiation modulo N and, for electrical curves, q as the number of points of this curve, even better choice options frequently being given.

A further possibility is that alternative equivalent encryption and/or decryption algorithms can be carried out in the arithmetic unit 1, which algorithms are selected randomly in accordance with the random number fed in.

In the case of the above-described modulation of the encryption and/or decryption algorithm, not only is the current consumption of the arrangement altered by the random number, but also the required computing time. The latter can, as measurable variable, also provide conclusions regarding the secret key. The same applies to the randomly controlled selection of the equivalent arithmetic operations.

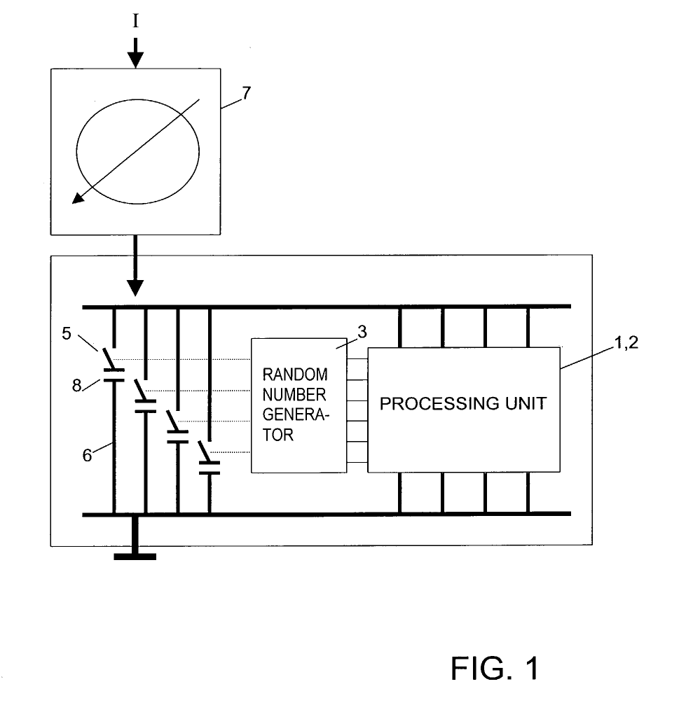

A third possibility is the provision of an additional circuit unit 6 (illustrated by dashed lines) in a manner similar to the exemplary embodiment according to FIG. 1, which additional circuit unit is likewise connected to the feeding device 4. The control device 2 then controls the additional circuit unit 6 in accordance with a random number fed from the random number generator 3 via the feeding device 4. An analysis of the current consumption of the overall arrangement illustrated is, consequently, determined not by the operation in the arithmetic unit 1 alone but also by a randomly controlled current consumption of the additional circuit unit.

In addition, it may be pointed out that the combination of modulation of the respective algorithm with an additional circuit unit 6 in the “dummy mode” is also expedient.

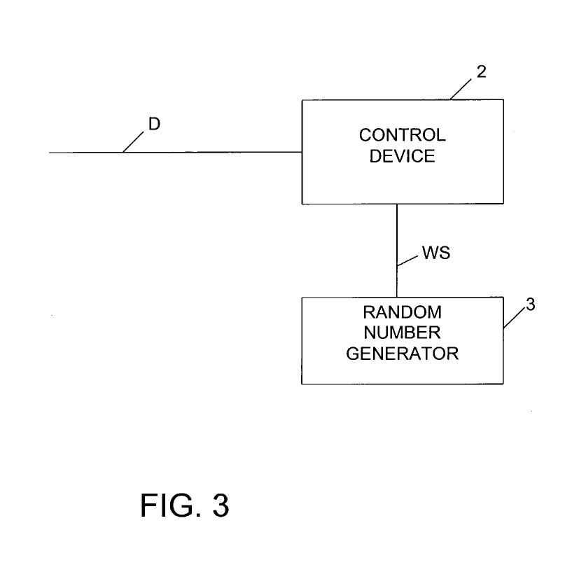

FIG. 3 shows a third exemplary embodiment according to the invention. In this case, data are fed via data terminal D to the control device 2, in the form of a CPU. At the same time, the “wait state terminal” WS is connected to a random number generator 3. This random number generator 3 then generates “ones” “zeros” in a random sequence. In accordance with the programming, the operation of the CPU is stopped or resumed whenever a “1” or “0” is present at the input. The result of this is that although the operation of the CPU is still synchronous with a clock generator (not illustrated), it no longer has uniform processing cycles. Since, in this way, a fixed uniform frame is no longer present, it is no longer possible easily to comprehend, by observation of the CPU, the operating procedures thereof and the latter can be analyzed only with a very high degree of difficulty. This means that the procedures to be processed in the CPU are “noisy”. In order to enhance the ease of operation of such an arrangement, the random number generator 3 can be programmed in such a way that it is possible to define the time frame in which processing maximally proceeds. This is necessary, inter alia, for establishing whether the system as a whole has failed.

It appears to be particularly expedient to combine an arrangement according to FIG. 3 with an arrangement according to FIG. 1 or 2 or with both, in order thereby to make it difficult, for example, to analyze the processing of an entire system.

We claim:

1. A data processing method, which comprises:
feeding data to be processed to a processing unit;
supplying a current to the processing unit for operating the processing unit; and
supplying in a randomly controlled manner a part of the current fed to the processing unit, to an auxiliary circuit.

2. The data processing method according to claim 1, wherein the step of supplying the part of the current to the auxiliary circuit is performed using a randomly controlled circuit.

3. The data processing method according to claim 2, wherein at least one capacitor is reloaded using the current supplied to the auxiliary circuit.

4. A data processing apparatus comprising
a computing device being fed data for processing and which is operated by a current;
an auxiliary circuit being connected in parallel to the computing device; and
a random number generator controlling the auxiliary circuit.

5. The apparatus according to claim 4, wherein the auxiliary circuit has at least one capacitor, which is reloaded by a switch controlled by the random number generator.
